(19) United States
(12) Patent Application Publication
(10) Pub. No.: US 2024/0392154 A1
(43) Pub. Date: Nov. 28, 2024

(54) DUAL-CURE EPOXY RESINS FOR 3D PRINTING OF HIGH-PERFORMANCE MATERIALS

(71) Applicant: NOGA 3D INNOVATIONS LTD, Rosh Haayin (IL)

(72) Inventors: Shlomo MAGDASSI, Jerusalem (IL); Iris BINYAMIN, Nes Ziona (IL)

(73) Assignee: NOGA 3D INNOVATIONS LTD, Rosh Haayin (IL)

(21) Appl. No.: 18/729,427

(22) PCT Filed: Jan. 18, 2023
(86) PCT No.: PCT/IL2023/050052

§ 371 Date: Jul. 16, 2024

Related U.S. Application Data
(60) Provisional application No. 63/266,889, filed on Jan. 18, 2022.

(51) Int. Cl. C09D 133/14; B33Y 70/00; C08F 220/32; C08G 59/17; C08G 59/50; C09D 163/00

(52) U.S. Cl. CPC C09D 133/14; B33Y 70/00; C08F 220/32; C08G 59/1466; C08G 59/5086; C09D 163/00

(57) ABSTRACT

The technology concerns formulations for additive manufacturing including dual-cure materials and multifunctional curing agents.

### FIELD OF THE INVENTION

The present invention is directed to compositions of dual-curable resins that cure upon exposure to radiation and thermal energy.

### BACKGROUND ART

High-performance materials (HPM) are lightweight materials compared to metals, that exhibit long term durability of chemical, mechanical, thermal and electric properties. They are typically used in aerospace aviation, automobile industry, electronic packaging, microelectronic insulation, corrosion resistance, films and medical implants. Three-dimensional (3D) printing of high-performance matrices is required in order to produce complicated and accurate objects that cannot be made by mold technique in fixed tools. Additive manufacturing (AM) is the prototype of 3D printing where 2D pattern is printed layer by layer to form the final 3D model. This technique is used in 3D printing of various high-performance polymers such as polyimide, polyether ketone and cyanate ester.

Epoxy resins such as Bisphenol A diglycidyl ether (DGEBA) and Novolac have been used extensively as matrices for high-performance composites in the aerospace industry since they fulfill the requirements of high modulus and high-temperature performance. However, these resins form a highly crosslinked polymer during polymerization, which is rigid and brittle. For example, the printing of a heated DGEBA-based formulation via hot lithography and polymerizing by cationic light polymerization forms a brittle polymer that cracks. Therefore, for practical applications in the HPM field, flexible additives were added for fracture improvement, without affecting the mechanical properties.

One approach to address this problem is by making hybrid resins. Hybrid resins are composed of a mixture of monomers with two kinds of functionalities that are selected to improve reaction rates and/or improve physical properties of the polymer formed. For example, hybrid acrylate-epoxide is composed of a mixture of monomers such as meth/acrylates and an epoxy monomer. This mixture undergoes simultaneous free-radical and cationic ring-opening polymerizations, respectively. By balancing the ratio of the two monomers, it is possible to control the physical and mechanical properties of the final polymer. This method was used for AM with a Digital Light Processing (DLP) printing unit. The polymerization mechanism was based on radical photopolymerization of the acrylates, and cationic photopolymerization of the epoxides. The result showed a lower epoxide polymerization compared to the acrylate; therefore, post-curing was needed. In one example, the ink was based on mixing acrylates with epoxy-anhydride components that were catalyzed by tertiary amine. In this case, the polymerization mechanism was based on radical photopolymerization of the acrylates and anionic thermal polymerization of the epoxides.

A variety of dual aliphatic and aromatic epoxyacrylate resins were reported, as shown in FIG. 1 [1,2]. Reportedly, monomer (i) in FIG. 1 was used for producing a fiber-reinforced composite material, while monomer (iv) was used as a crosslinker in diepoxide-diacrylate hybrid ink. Bifunctional monomers (ii), (iii) and oligomer (v) were photopolymerized with multifunctional thiols. Oligomer (v) was used for coating, e.g., the oligomer was polymerized by UV and heat, in the presence of graphene oxide and trimethylpropane triacrylate as a reactive diluent [3].

The bifunctional monomers form a uniform polymers network with a high polymerization rate. When cationic photoinitiators, such as diaryliodonium or triarylsulfonium, are applied in combination with a radical photoinitiator, the process yields a gel with almost complete photopolymerization of the acrylates, and partial polymerization of the epoxide. Following this reaction, heat is needed for an additional post-curing process.

Bisphenol A epoxide-monoacrylate (BAEMA) dual resin was synthesized by a one-step esterification reaction of DGEBA and acrylic acid (FIG. 2). The final cured polymer had higher glass transition temperature (Tg) and adhesion strength, compared to a cured hybrid epoxide made of blending bisphenol A diacrylate and DGEBA. For this reason, BAEMA was used for coating.

BAEMA is a highly viscous resin that necessitates presence of an additive to be more easily usable. A composition based on BAEMA of DGEBA and the bisphenol A diacrylate, was made to yield a polymer with outstanding Young's modulus, surface hardness and transparency. J. Cushen et al from CARBON Inc. demonstrated formulations for AM that included up to 40% (wt.) BAEMA mixed with epoxide and acrylate oligomers, a diluent, a photoinitiator and a hardener [4]. The formulations optionally also included solid fillers, such as silicates. It was found that BAEMA reduced cracking with aromatic amines and anhydride hardeners and reduces phase separation. Poeller et al from Henkel AG & Co. KGAA combined BAEMA (1-15 wt %) with meth/acrylate and epoxide monomers, also for AM. The compositions contained radical and cationic curing catalyst, or latent hardeners such as melamine resins. Addition of solid fillers such as disperse silica (1-90 wt. %) formed a pasty dual cure formulation [5].

U.S. Pat. No. 10,975,193 [6] and WO 2020/229444 [7] demonstrate the use of solid organic or inorganic fillers, in order to improve the mechanical properties of the final polymer. The inorganic particles used included solid metal oxides such as SiO₂, TiO₂, ZrO₂ and Al₂O₃.

A different approach for including fillers composed of metal oxides is based on addition of sol-gel precursors to the epoxy formulation in order to form in situ inorganic metal oxide particles. The process involves a series of hydrolysis steps of metal alkoxide and condensation reactions, to yield the final filler. The advantages of this technique compare to nanoparticle dispersion are: 1) avoiding aggregation phenomena of the particles, 2) avoiding formulation viscosity and using the inorganic precursor as reactive diluent, 3) the inorganic precursor may serve as a crosslinker to the epoxy polymer due to interfacial bonding between the silica and epoxy networks, and 4) The nanoparticles forms allow thin layer bond lines and high resolution in the printing process. This approach was demonstrated for hardening DGEBA resin by 3-glycidyloxypropyltrimethoxysilane, TEOS as well as titanium and zirconium precursors and the formation of organic-inorganic hybrid material.

### PUBLICATIONS

[1] Epoxy monoacrylate synthesis and photopolymerization in a thiol-ene/cationic hybrid system, J. Zhou; Q. Zhang: H. Zhang; S. Chen; Q. Liu, J. Polym. Res. 2012, 19, 9984.
[2] Curable composition, adhesive, method of producing fiber-reinforced composite materials, and fiber-reinforced composite material, Y. Tadokoro; H. Chisaka; K. Noda; D. Shiota, US 2015/0252229, Sep. 10, 2015.
[3] Preparation and transparent nanocomposites from UV- and thermo-curable epoxyacrylate and graphene oxide for the application of corrosion protection coating. C.-F. Syu; Y.-T. Lin; Y.-C. Yeh: T.-M. Don, Polym. Int. 2019, 68, 1804.
[4] Epoxy Dual cure resins formulations for 3D printing applicfor additing manufacturing, J. D. Cushen, J. Goodrich, J. P. Rolland U.S. Pat. No. 10,975,193, Apr. 13, 2021.
[5] Dual cure epoxy formulations for 3D printing applications, S. Poeller; T. Rossberg; L. Zhao; A. Ferencz; M. Schiel; T. Welters, WO 2020/229444, Nov. 19, 2020.
[6] U.S. Pat. No. 10,975,193.
[7] WO 2020/229444.

### SUMMARY OF INVENTION

The present invention concerns use of a bifunctional oligomer such as bisphenol A epoxide-monoacrylate (BAEMA), shown below, having both acrylate and epoxy groups, in additive manufacturing of objects composed of high-performance materials.

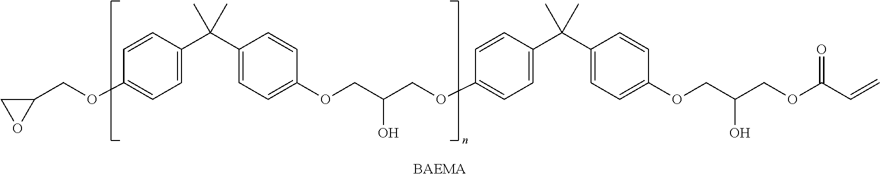

The oligomers are selected and structured to polymerize by both epoxy and vinyl groups and the number of each type of groups can vary. In the non-limiting example of BAEMA, the molecule contains one acrylic and one epoxy group.

As noted above, BAEMA is a highly viscous resin, which has been utilized as a coating material or as an adhesive or a component in adhesive materials. Despite its high viscosity, the inventors have tailored printing formulations which comprise the oligomer and other suitable additives that in combination can be used for additive manufacturing under conditions of light-mediated and heat-mediated curing.

Thus, in a first aspect, there is provided a formulation comprising a dual-cure material (being a monomer or an oligomer) and a multifunctional curing agent for use in a method of additive manufacturing, wherein the formulation optionally comprises an ink carrier or a carrier suitable for printing.

Also provided is a formulation comprising a dual-cure material in a form of a monomer or an oligomer, and a multifunctional curing agent for use in a method of light-mediated additive manufacturing.

As known in the art, “additive manufacturing” refers generally to any process of joining materials to make objects from a 3D model data, usually through layer-by-layer deposition. Additive manufacturing may be used to form objects of the dual-cure materials disclosed herein by causing light-mediated polymerization or photopolymerization to bring about polymerization of the acrylic-epoxy monomers by activating a photoactive radical or cationic species with a light source. Thus, formulations of the invention may further comprise at least one photoinitiator that is capable of generating photoactive radical or cationic species.

In some embodiments, formulations of the invention may comprise the at least one additive which may be one or a combination of additives selected to improve the printing functionality, including radical scavenger, dyes, rheological agents, diluents and surfactants.

The “dual-cure” materials used according to the invention are polymerizable monomers or oligomers having one or more, or at least one epoxy functionality and one or more, or at least one acrylate functionality. The dual-cure material is thus capable of polymerization or curing through both the epoxy functionality and the acrylate functionality by way of thermal and light-mediated processes.

The dual-cure material may be a liquid or a solid at room temperature and may be selected, inter alia, based on its structure, molecular weight, the material properties such as solubility and melting or boiling points, and other factors. Thus, the dual-cure material may be selected amongst any such materials known in the art, which may contain one or more than one reactive epoxy or acrylic groups. The dual-cure materials may thus be selected amongst commercially available materials, such as but not limited to dual-cure materials based on epoxyphenol novolac (EPN) or epoxycresol novolac (ECN) and others, or amongst synthetic dual-cure materials. Irrespective of whether or not the material is commercially available or synthetized, it is generally of structure (I):

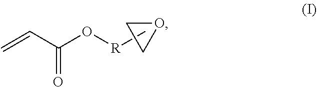

wherein the oxirane ring may be associated with group R via any of the oxirane carbon atoms or may be fused to a group R (in such cases where R is or comprises a ring structure which may or may not be aromatic).

In some embodiments, R is a ring structure or a functionality having a cyclic or an aromatic group, wherein the oxirane ring is fused thereto.

Group R is a variant group which is substituted by both the acrylate and the epoxide (oxirane) functionalities. Variant R may be a carbon-based group having between 1 and several hundred or more carbon atoms and which may be selected from aliphatic groups, aromatic groups, heteroaromatic groups, carbocyclic groups, saturated groups, unsaturated groups, and others.

In some embodiments, group R is a building block or a ‘mer’ unit which may be repeated 1 or more times (e.g., between 1 and 100 times), wherein each building block is an alkylene (and/or a carbocyclyl) group having between 1 and 100 carbon atoms, an alkenylene group having between 2 and 100 carbon atoms or an alkynylene group having between 2 and 100 carbon atoms, each of which being optionally substituted. The building block may alternatively be a carbocyclyl group or an aromatic or a heteroaromatic group, that is optionally substituted.

In some embodiments, group R is an alkylene group having between 1 and 100 carbon atoms, an alkenylene or alkynylene group having between 2 and 100 carbon atoms, which may be further substituted. Group R may alternatively be a carbocyclyl group or an aromatic or a heteroaromatic group, that is optionally substituted.

As used herein, the term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The “alkyl” or “alkylene” refers to a radical of a straight-chain or branched saturated hydrocarbon group having from 1 to 100 carbon atoms. In some embodiments, an alkyl/alkylene group has 1 to 20 carbon atoms. In some embodiments, an alkyl/alkylene group has 1 to 50 carbon atoms. Examples of alkyl groups include methyl, ethyl, propyl (e.g., n-propyl, isopropyl), butyl (e.g., n-butyl, tert-butyl, sec-butyl, isobutyl), pentyl (e.g., n-pentyl, 3-pentanyl, amyl, neopentyl, 3-methyl-2-butanyl, tert-amyl), hexyl (e.g., n-hexyl), and others. Any of the alkyl/alkylene groups may be substituted as disclosed herein.

The “heteroalkyl/heteroalkylene” is an alkyl or an alkylene group, which further includes at least one heteroatom (e.g., 1, 2, 3, or 4 heteroatoms) selected from oxygen, nitrogen, or sulfur, which may be substituted on the carbon chain, may be a part of a substituent or may be an interrupting atom provided along a carbon chain.

The “alkenyl/alkenylene” refers to a radical of a straight-chain or branched hydrocarbon group having from 2 to 100 carbon atoms and one or more carbon-carbon double bonds (e.g., 1, 2, 3, or 4 double bonds), which may be in the (E)- or (Z)-configuration.

The “alkynyl/alkynylene” refers to a radical of a straight-chain or branched hydrocarbon group having from 2 to 100 carbon atoms and one or more carbon-carbon triple bonds (e.g., 1, 2, 3, or 4 triple bonds).

The “carbocyclyl” or “carbocyclic” refers to a radical of a non-aromatic cyclic hydrocarbon group having from 3 to 100 ring carbon atoms and no heteroatoms in the ring structure. Exemplary carbocyclyl groups include cyclopropyl, cyclopropenyl, cyclobutyl, cyclobutenyl, cyclopentyl, cyclopentenyl, cyclohexyl, cyclohexenyl, cyclohexadienyl, cycloheptyl, cyclooctyl, cyclooctenyl, bicyclo[2.2.1]heptanyl, bicyclo[2.2.2]octanyl, cyclodecenyl, octahydro-1H-indenyl, and others. The carbocyclic system may be a single ring structure or a multiring, e.g., fused, structure. Similarly, the carbocyclic system may be monocyclic or polycyclic containing a fused, bridged or spiro ring system.

The “heterocyclyl” or “heterocyclic” is a non-aromatic ring system of 3 to 100 carbon atoms, which comprises one or more heteroatoms independently selected from nitrogen, oxygen, and sulfur. Examples of heterocyclic systems include azirdinyl, oxiranyl, thiiranyl, azetidinyl, oxetanyl, thietanyl, tetrahydrofuranyl, dihydrofuranyl, tetrahydrothiophenyl, dihydrothiophenyl, pyrrolidinyl, dihydropyrrolyl, oxadiazolinyl, thiadiazolinyl, and others.

Unlike the heterocyclic systems, the “aryl” system refers to a radical of a monocyclic or polycyclic (e.g., bicyclic or tricyclic) aromatic ring system having 6-14 ring carbon atoms and no heteroatoms.

The “heteroaryl” refers to a radical of a 5 to 100 carbon atoms, forming a monocyclic or polycyclic (e.g., bicyclic, tricyclic) aromatic ring system, having ring carbon atoms and 1 to 4 ring heteroatoms elected from nitrogen, oxygen, and sulfur.

As used herein, the “unsaturated” group comprises a double or triple bond and the “saturated” group does not contain a double or triple bond, e.g., the moiety only contains single bonds.

Each of the groups defining variant R, namely each of the carbon-based groups having between 1 and several hundred or more carbon atoms and which may be selected from aliphatic groups, aromatic groups, heteroaromatic groups, carbocyclic groups, saturated groups, unsaturated groups, etc, may be independently substituted with one or more groups selected from halogens, —CN, —NO₂, —N₃, —SO₂H, —SO₃H, —OH, —OX, —ON(X)₂, —N(X)₂, —N(OX)X′, —SH, —SX, —SSX, —C(═O)X, —CO₂H, —CHO, —CO₂X, —OC(═O)X, —OCO₂X, —C(═O)N(X)₂, —SO₂X, —SO₂OX, —OSO₂X, —S(═O)X, —OS(═O)X, —Si(X)₃, —OSi(X)₃—C(═O)SX, —C(═S)SX, —SC(═S)SX, —SC(═O)SX, C1-C20 alkyl, C1-C20 perhaloalkyl, C1-C20 alkenyl, C1-C20 alkynyl, heteroC1-C20 alkyl, heteroC1-C20 alkenyl, heteroC1-C20 alkynyl, C3-C10 carbocyclyl, heterocyclyl, aryl, and heteroaryl, wherein each instance of X or X′ is an independent group that is independently selected from hydrogen, alkyl, alkenyl, alkynyl or aryl, as defined.

In some embodiments, R is an alkylene group comprising 1 to 5 carbon atoms that is further substituted to provide a carbon group substituted with one or more epoxide ring structure and one or more acrylate group. In some embodiments, R is a methylene group (—CH₂—) that is further substituted as shown in the dual-cure material of general structure (II):

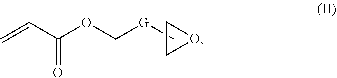

wherein G is a carbon group (e.g., selected amongst aliphatic groups, aromatic groups, heteroaromatic groups, carbocyclic groups, saturated groups, unsaturated groups, etc) comprising between 2 and 50 carbon atoms, and optionally comprising one or more ring structures selected from 4-, 5- and 6-membered carbocyclic, aromatic or heteroaromatic ring systems.

In some embodiments, in a dual-cure material of structure (II), the oxirane group is fused to a 4-, 5- or 6-membered carbocyclic, aromatic or heteroaromatic ring.

In some embodiments, group G is or comprises a 4-, 5- or 6-membered carbocyclic, aromatic or heteroaromatic ring that is fused or substituted to the oxirane ring.

In some embodiments, group G is or comprises a 5- and/or a 6-membered carbocyclic ring that is fused or substituted to the oxirane ring.

In some embodiments, G is selected from:

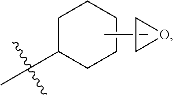

wherein the dashed line designates a bond of connectivity to the methylene carbon in a structure (II) and wherein the oxirane ring may be substituted on any of the ring positions of the 6-membered ring or may be fused to any bond of the 6-membered ring;

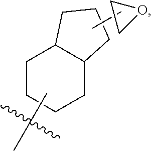

wherein the dashed line designates a bond of connectivity to the methylene carbon in a structure (II), said connectivity being through any of the carbon atoms of the 6-membered ring, and wherein the oxirane ring may be substituted on any of the ring positions of the 5-membered ring or may be fused to any bond of the 5-membered ring;

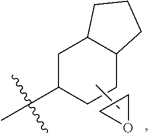

wherein the dashed line designates a bond of connectivity to the methylene carbon in a structure (II), and wherein the oxirane ring may be substituted on any of the ring positions of the 6-membered ring or may be fused to any bond of the 6-membered ring;

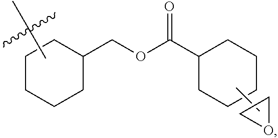

wherein the dashed line designates a bond of connectivity to the methylene carbon in a structure (II), and wherein the oxirane ring may be substituted on any of the ring positions of the 6-membered ring or may be fused to any bond of the 6-membered ring; and
wherein each of the carbon atoms in any of variant G may be substituted as disclosed herein.

Non-limiting examples of such dual-cure materials include

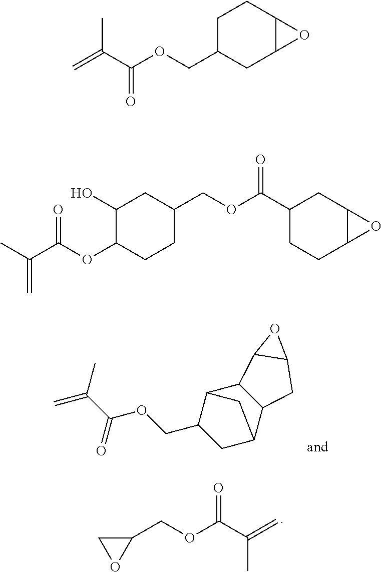

In some embodiments, the dual-cure material is BAEMA.

In some embodiments, formulations of the invention comprise a dual-cure material of formula (I) or (II), defined as above.

In some embodiments, the dual-cure material of formula (I) and (II) is BAEMA.

Formulations of the invention further contain multifunctional curing agents. The multifunctional curing agent is a hardener material comprising two or more functionalities, which may be the same or different, each having reactivity towards the dual-cure material. The multifunctional material may be anhydride-based, amine-based, cyanate-based, polyamide, polyols, and aromatic amines. Non-limiting examples include methylene dianiline, diethyl aminopropylamine, diethylenetriamine, ethylenediamine, m-phenylenediamine, tris-(dimethylaminomethyl) phenol, triethylenetetramine, dicyandiamide, isopropyl metaphenylenediamine, hexahydrophthalic anhydride, 4,4-methylen-bis-(2-chloraniline), alkylated melamines (such as C1-C10 alkylated melamines, e.g., methylated, propylated, butylated, etc), cyanate esters, polyphenols, aromatic diisocyanate (e.g., 1,5-naphthalene diisocyanate, 1,4-phenylene diisocyanate, toluene diisocyanate, 3,3′-Dimethyl-4,4′-biphenylene diisocyanate) and others. Additional examples are disclosed for example in US patent application no. 2017/0369427, herein incorporated by reference.

In some embodiments, the at least one multifunctional curing agent is selected from melamine, melamine derivatives, cyanate esters, phenols and aromatic amines. Examples of such materials include:
a. Melamine derivatives such as alkylated melamine (e.g., methylated 303 LF/Cymel/butylated and mixtures thereof, for example NF 2000A/Cymel), in an amount of 20-50% by weight; and/or
b. Cyanate ester, in an amount of 20-50% by weight; Novolac cyanate ester, in an amount of 1-9% by weight, and their mixtures; and/or
c. Phenol based hardeners-such as without limitation phenol formaldehyde resin (Novolac) (e.g., Phenodur PR 401/72B, Alnovol PN 650/60B, Allnex), Novolac alkyl phenols (examples are given in WO 2017/153050, US 2005/0014086, each of which being herein incorporated by reference), in an amount of 20-40% by weight, polyphenols (e.g. tannic acid, resoles, biopolyols, in an amount of <5% by weight.

In some embodiments, the multifunctional curing agent is a polyphenol such as a phenol copolymer, present in an amount of 5-50% by weight.

In some embodiments, the multifunctional curing agent is an inorganic precursor or a sol gel precursor that is soluble in the formulation. This material is not an inorganic particulate matter. In some embodiments, the inorganic precursor or sol gel precursor is added in order to form metal oxide particles which serve as fillers, or to bind directly to the resin and act as a crosslinker. An in situ sol gel process can take place in two ways:
a. A one-step sol gel—in case liquid precursors and additives are mixed with the epoxide components in one pot.
b. A two-step preparation of a homogenous sol solution from the liquid precursor, followed by addition to the epoxide components.

Either way, an intermediate M-OH moiety is formed (wherein M is a metal atom), which can react with similar components or with an epoxide group of the dual-cure material. The sol gel precursors may include di-, tri- and tetra-alkoxysilane (e.g. tetraethoxysilane (TEOS), (3-isocyanatopropyl)trimethoxysilane); bisaminosilane; acryloxymethyltrimethoxysilane; methyltriethoxysilane; dimethyldimethoxysilane; phenyltrimethoxysilane; acryloxypropyltrimethoxysilane (APTMS); (3-glycidoxypropyl)trimethylsilane; silanols such as silanediols, silanetriols, and trisilanolPhenyl (POSS); aluminum lactate; aluminum alokoxides such as aluminum isopropoxide; aluminum chloride; tris (ethyl acetoacetate) aluminum; zirconium alkoxide such as zirconium propoxide; zirconium nitrate; titanium alkoxide such as titanium isopropoxide, titanium n-butoxide and titanium ethoxide; niobium ethoxide. The sol-gel precursor may be present in an amount of <40% by weight.

The dual-cured materials used in formulations of the invention, such as BAEMA, may be photopolymerized by visible or UV or NIR or IR light to form in situ crosslinked polymer structures, typically at low temperatures. The photoinitiator used to generate an active species capable of inducing polymerization (radical species or a cationic species) may be selected amongst such photoinitiators known in the art. In some non-limiting embodiments, the photoinitiator is selected amongst free radical photoinitiators such as diphenyl (2,4,6-trimethylbenzoyl)phosphine oxide (TPO), acetophenone, Irgacure 651, Irgacure 819, 1-phenyl-1,2-propanedione (PPD).

The amount of the photoinitiator is typically between 0.1-4 wt %.

In some embodiments, a latent initiator may be utilized. In such cases, the latent initiator may be activated by light irradiation or by heat. Examples for such initiators include bisphenyl iodonium salt derivatives (e.g., diphenyliodonium hexafluorophosphate (DPI), in an amount of <4% by weight, and triarylsulfonium hexafluorophosphate (TAS), present in an amount of <8% by weight.

Formulations of the invention may comprise organometallic catalysts. Where isocyanates are utilized, the organometallic catalyst may be zinc (II) acetylacetnate hydrate in isobornyl acrylate (e.g., in an amount of 3000 ppm). Additional examples are disclosed in U.S. Pat. No. 10,471,655, herein incorporated by reference.

At least one light absorber may also be present in formulations of the invention. In some embodiments, the light absorber is a reactive dye that adsorb UV light. Where present it may be used to improve the printing resolution. Examples of light absorbers include thioxanthone and sulforhodamine B sodium salt. The light absorber material may be present in an amount of 0.5% and 0.005% by weight.

At least one acid generator, such as a thermal acid generator (e.g., K-Pure CXC-1612 and K-Pure CXC-1614) may be optionally added. The amount of the acid generator may be between 0.1 to 3.0 wt %. In some embodiments, acrylic acid at low concentrations are utilized as the acidic catalyst.

Optionally also a toughener may be added to the formulation. The toughener may be selected amongst liquid or solid crosslinking agents (e.g., 1,3,5-Triacryloylhexahydro-1,3,5-triazine, acrylo-POSS, Bisphenol A diacrylate, Tris(2,3-epoxypropyl) isocyanurate, octaglycidyldimethylsilyl POSS, triglycidyl isocyanurate). Other examples include epoxidize oils (e.g. soybean, palm, castor), o-Cresol novolac epoxy, Novolac epoxy. The amount of the toughener may be <15 wt %.

Further tougheners may include but not limited to CO₂ gas, renewable resources (e.g. rice husks, jute), lignin, Tannic acid, cardanol, sorbitol. These may be included in an amount of <15% by weight.

In some embodiments a particulate filler may be added. The filler may be solid organic or inorganic particles, and may include carbonaceous materials (e.g. carbon nanotubes, graphene, carbon black, nanofibers), thermoplastic polymers (e.g. acrylonitrile-butadiene-styrene (ABS), polyetherimide (PEI)), silicates (e.g. silica, mica, talc, clays), silicon carbide and other known fillers. The amount of the filler is typically <10 wt %.

Formulations of the invention may further comprise carbonaceous materials and other functional materials such as graphite, short carbon fibers, carbon nanotubes (CNT), fused silica particles, Graphene oxide, and 2D materials such as boron nitride (BN), MoS₂ and WS₂.

Formulations of the invention further comprise diluents, solvents and carriers as may be needed to formulate a proper ink formulation.

In some embodiments, the diluent is a high boiling point reactive diluent which comprises a chemical functionality such as OH, NH₂, meth/acrylate and epoxide (e.g. Bisphenol A ethoxylated, Bisphenol F diglycidyl ether, Bisphenol A diacrylate, 1-Phenoxy-2-propanol, 3,4-epoxycyclohexylmethyl-3,4-epoxycyclohexane carboxylate (EPOX), alkylated lactate (e.g. ethyl, butyl), benzyl alcohol, styrene, acetoacetate (e.g. K-Flex 7301/King Industries). The amount of the reactive diluent may be <15% by weight. The reactive diluent is capable of reacting with components of the formulations after performing the printing process.

The carrier or solution medium is typically organic. However, for some uses, the carrier medium may contain inactive inorganic solvents or water.

In embodiments, the carrier may comprise metal alkoxides liquid precursors. The precursors undergo hydrolysis and polycondensation reactions, to form metal oxide fillers and polymer crosslinking. The amount of the precursors may be <3 equivalents of the active groups in the precursor.

The formulation may be maintained at acidic or neutral pH. In some embodiments, a buffer may be used.

In some embodiments, the formulation is maintained at acidic pH, e.g., at pH=4.

Formulations of the invention may be used as ink formulations for manufacturing 3D objects or patterns by additive manufacturing. Typically processes of the invention comprise deposition of an ink formulation, as defined herein, e.g., a formulation comprising a dual-cure material, a multifunctional curing agent, at least one photoinitiator and optionally one or more additives, onto a surface region of a substrate under irradiation conditions followed by thermal curing to cause formation of a radical or cationic species effective to polymerize the dual-cured material in the presence of the multifunctional material.

Processes of the invention may comprise layer-by-layer deposition and photopolymerization to obtain a 3D object or pattern composed of a polymeric material having a Tg higher than 180° C.

Thus, in another aspect, there is provided a process for forming a 3D object or pattern, the process comprising inducing polymerization of at least one dual-cure material in presence of a multifunctional curing agent and a photoinitiator, to form a crosslinked polymer structure or pattern, wherein the induction of polymerization comprises irradiation of the at least one dual-cure material in presence of the multifunctional curing agent and the photoinitiator by visible or UV or NIR or IR radiation.

In some embodiments, the method comprising inducing polymerization by visible or UV or NIR or IR light to form in situ crosslinked polymer structures, followed by thermal curing.

Without wishing to be bound by theory, the acrylate groups of the BAEMA resin undergo fast radical polymerization when exposed to UV radiation in the presence of a photoinitiator such as TPO. The photoinitiator produces radicals and initiates the radical reaction to form a polymer, which enable rapid fixation during the 3D printing process. When this polymer is heated in the presence of a multifunctional curing agent or a hardener such as alkylated melamine (such as C1-C10 alkylated melamines), crosslinking occurs via a transesterification reaction between the hardener and hydroxyl groups of BAEMA (as depicted fro example in FIG. 3). In addition, a rection between epoxide groups of BAEMA with alkylated melamine leads to a highly crosslinked and stable polymer, with the formation of five and six membered rings (as depicted for example in FIG. 4).

As disclosed herein, additive manufacturing is a process of depositing materials, usually layer upon layer, to make objects from a 3D computer-aided design (CAD) model. Materials and processes for special utility products, such as those used in aerospace and automotive applications raise several challenges, including low mass requirement, small production series, challenging material procurement, very high performances, and very high reliability. Additive manufacturing is well-suited for such applications: it is adaptive to very small series, applicable to dimensions range from few micrometers to meters, applicable to a wide variety of materials (polymers, metals, ceramics, composites, tissues and living cells, food for astronauts, etc.), allows for complex geometries that could not be manufactured before, enables reduction of interfaces (e.g., flanges, connectors, cables), allows significant mass reduction, provides performance improvement, short lead time, minimal material waste, and could be used for spacecraft construction and even for in-orbit manufacturing.

The use of polymers formed according to processes of the invention or from formulations of the invention in space applications has obvious advantages. The polymerization process is cost effective since it can be performed by common stercolithography-based printers. Highly accurate models can be printed to form 3D objects with superior chemical, physical and mechanical properties, non-flammability, isolator, light weight and near zero moisture absorbance.

Thus, products of processes of the invention may be characterized as polymeric objects, structures or patterns, which may be of any shape and size and which have a Tg higher than 180° C., hence can be implemented in a variety of applications. Generally speaking, products of the invention formed from a dual-cure material as disclosed herein may be implemented for aerospace aviation, automobile industry, electronic packaging, microelectronic insulation, corrosion resistance, films, medical device, medical implants, as well as in many other fields.

Unlike the common approach of blending epoxy and acrylate monomers to enable both photopolymerization and thermal curing, a bifunctional oligomer, having both acrylate and epoxy groups within the same molecule is used. This oligomer is combined with unique multifunctional hardeners, such as alkylated melamine (Cymel) and/or cyanate esters, and silica precursor (AMTMS). The fabrication process is composed of DLP printing, thus forming the required object by photopolymerization of the oligomer, followed by heat curing the epoxides with Cymel. This specific hardener led to the formation of a highly crosslinked, high-performance polymer characterized by superior properties: excellent Tg (241° C.) with Young's modulus of 2.43 Gpa and UTS value of 37.5 MPa.

Further addition of the sol-gel dual precursor AMTMS provided a unique multifunction: photopolymerization, crosslinking, and forming silica particles. The combination of all three led to the extremely high Tg value of 283° C., excellent Young's modulus of 2.85 GPa, and UTS value of 44.25 MPa.

The invention thus further provides a formulation comprising a dual-cure material, such as BAEMA, multifunctional hardener, such as alkylated melamine (such as C1-C10 alkylated melamines) and/or cyanate esters.

In some embodiments, the formulation is used in DLP printing of a 3D object.

In some embodiments, the 3D object is characterized by a Tg or 241° C., Young's modulus of 2.43 Gpa and an ultimate tensile strength (UTS) value of 37.5 MPa.

The invention thus further provides a formulation comprising a dual-cure material, such as BAEMA, multifunctional hardener, such as alkylated melamine (such as C1-C10 alkylated melamines) and/or cyanate esters, and a silica precursor such as AMTMS.

In some embodiments, the formulation is used in DLP printing of a 3D object.

In some embodiments, the 3D object is characterized by a Tg of 283° C., Young's modulus of 2.85 GPa, and UTS value of 44.25 MPa.

The invention provides formulations, uses thereof, processes, method and 3D objects:

A formulation comprising a dual-cure material being in a form of a monomer or an oligomer, and a multifunctional curing agent, for use in a method of additive manufacturing, wherein the formulation optionally comprises an ink carrier or a carrier suitable for printing.

A formulation comprising a dual-cure material in a form of a monomer or an oligomer, and a multifunctional curing agent for use in a method of light-mediated additive manufacturing.

In any formulation of the invention, the formulation may further comprise the at least one additive selected from radical scavengers, dyes, rheological agents, diluents and surfactants.

In any formulation of the invention, the dual-cure material may be a polymerizable monomer or oligomer having one or more epoxy functionality and one or more acrylate functionality.

In any formulation of the invention, the dual-cure material may be selected to polymerize or cure under thermal and light irradiation conditions.

In any formulation of the invention, the dual-cure material may be of the structure (I):

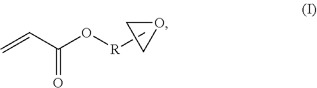

wherein the oxirane ring is associated with group R via any of the oxirane carbon atoms or is fused to a group R.

In any formulation of the invention, R may be a ring structure or a functionality having a cyclic or an aromatic group, wherein the oxirane ring is fused thereto.

In any formulation of the invention, R may be a carbon-based group selected from aliphatic groups, aromatic groups, heteroaromatic groups, carbocyclic groups, saturated groups, and unsaturated groups.

In any formulation of the invention, R may be repeated 1 or more times, wherein each R is an alkylene group having between 1 and 100 carbon atoms, an alkenylene group having between 2 and 100 carbon atoms or an alkynylene group having between 2 and 100 carbon atoms, each of which being optionally substituted.

In any formulation of the invention, R may be a carbocyclyl group or an aromatic or a heteroaromatic group, that is optionally substituted.

In any formulation of the invention, R may be an alkylene group comprising 1 to 5 carbon atoms.

In any formulation of the invention, R may be a methylene group.

In any formulation of the invention, the dual-cure material may be of general structure (II):

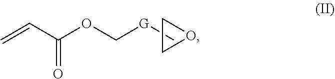

wherein G is a carbon group comprising between 2 and 50 carbon atoms, and optionally comprising one or more ring structures selected from 4-, 5- and 6-membered carbocyclic, aromatic or heteroaromatic ring systems.

In any formulation of the invention, the oxirane group may be fused to a 4-, 5- or 6-membered carbocyclic, aromatic or heteroaromatic ring.

In any formulation of the invention, G may be or comprises a 4-, 5- or 6-membered carbocyclic, aromatic or heteroaromatic ring that is fused or substituted to the oxirane ring.

In any formulation of the invention, G may be or comprises a 5- and/or a 6-membered carbocyclic ring that is fused or substituted to the oxirane ring.

In any formulation of the invention, G may be selected from:

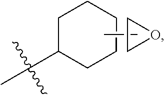

wherein the dashed line designates a bond of connectivity to the methylene carbon in structure (II) and wherein the oxirane ring may be substituted on any of the ring positions of the 6-membered ring or is fused to any bond of the 6-membered ring;

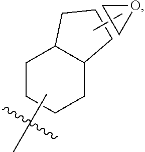

wherein the dashed line designates a bond of connectivity to the methylene carbon in a structure (II), said connectivity being through any of the carbon atoms of the 6-membered ring, and wherein the oxirane ring is substituted on any of the ring positions of the 5-membered ring or is fused to any bond of the 5-membered ring;

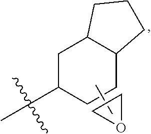

wherein the dashed line designates a bond of connectivity to the methylene carbon in a structure (II), and wherein the oxirane ring is substituted on any of the ring positions of the 6-membered ring or is fused to any bond of the 6-membered ring;

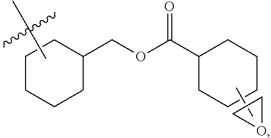

wherein the dashed line designates a bond of connectivity to the methylene carbon in a structure (II), and wherein the oxirane ring is substituted on any of the ring positions of the 6-membered ring or is fused to any bond of the 6-membered ring.

In any formulation of the invention, the dual-cure material may be selected from:

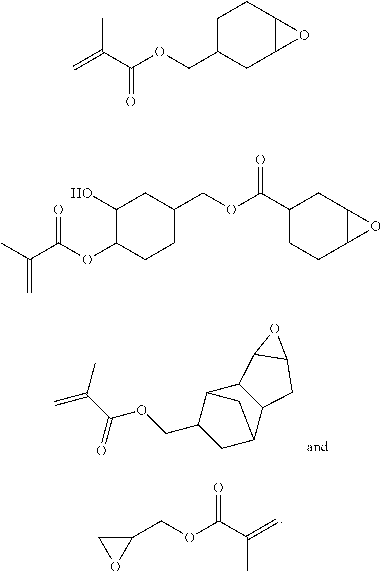

In any formulation of the invention, the dual-cure material may be BAEMA.

In any formulation of the invention, the multifunctional curing agent may be selected from methylene dianiline, diethyl aminopropylamine, diethylenetriamine, ethylenediamine, m-phenylenediamine, tris-(dimethylaminomethyl) phenol, triethylenetetramine, dicyandiamide, isopropyl metaphenylenediamine, hexahydrophthalic anhydride, 4,4-methylen-bis-(2-chloraniline), alkylated melamines, cyanate esters, polyphenols and aromatic diisocyanate.

In any formulation of the invention, the aromatic diisocyanate may be selected from 1,5-naphthalene diisocyanate, 1,4-phenylene diisocyanate, toluene diisocyanate, and 3,3′-Dimethyl-4,4′-biphenylene diisocyanate.

In any formulation of the invention, the multifunctional curing agent may be selected from melamine, melamine derivatives, cyanate esters, phenols and aromatic amines.

In any formulation of the invention, the multifunctional curing agent may be selected from melamine and alkylated melamine.

In any formulation of the invention, the alkylated melamine may be a methylated melamine or butylated melamine or mixtures thereof.

In any formulation of the invention, the multifunctional curing agent may be a cyanate ester.

In any formulation of the invention, the multifunctional curing agent may be a phenol-based hardener.

In any formulation of the invention, the formulation may further comprise an inorganic precursor or a sol gel precursor soluble in the formulation.

In any formulation of the invention, the sol-gel precursor may be di-, tri- and tetra-alkoxysilane.

In any formulation of the invention, the sol-gel precursor may be selected from tetraethoxysilane (TEOS), (3-isocyanatopropyl)trimethoxysilane); bisaminosilane; acryloxymethyltrimethoxysilane; methyltriethoxysilane; dimethyldimethoxysilane; phenyltrimethoxysilane; acryloxypropyltrimethoxysilane (APTMS); (3-glycidoxypropyl) trimethylsilane; silanediols; silanetriols; trisilanol phenyl (POSS); aluminum lactate; aluminum alokoxides; aluminum isopropoxide; aluminum chloride; tris (ethyl acetoacetate) aluminum; zirconium alkoxide; zirconium propoxide; zirconium nitrate; titanium alkoxide; titanium isopropoxide, titanium n-butoxide; titanium ethoxide; and niobium ethoxide.

In any formulation of the invention, the formulation may further comprise a photoinitiator suitable for generating an active species capable of inducing polymerization.

In any formulation of the invention, the photoinitiator may be selected from diphenyl (2,4,6-trimethylbenzoyl) phosphine oxide (TPO), acetophenone, Irgacure 651, Irgacure 819, and 1-phenyl-1,2-propanedione (PPD).

In any formulation of the invention, the formulation may further comprise a toughener, particulate filler material, carbonaceous materials and functional materials. The formulation according to claim 32, wherein the functional material is graphite, short carbon fibers, carbon nanotubes (CNT), fused silica particles, Graphene oxide, and 2D materials.

In any formulation of the invention, the 2D material may be boron nitride (BN), MoS2 or WS2.

In any formulation of the invention, the formulation may further comprise a diluent, a solvent or a carrier.

In any formulation of the invention, the diluent may be a high boiling point reactive diluent comprising a chemical functionality such as —OH, —NH2, meth/acrylate and epoxide.

In any formulation of the invention, the diluent may be Bisphenol A ethoxylated, Bisphenol F diglycidyl ether, Bisphenol A diacrylate, 1-Phenoxy-2-propanol, 3,4-epoxycyclohexylmethyl-3,4-epoxycyclohexane carboxylate (EPOX), alkylated lactate, benzyl alcohol, styrene, or acetoacetate.

In any formulation of the invention, the formulation may be maintained at acidic or neutral pH.

In any formulation of the invention, the formulation may be use in a method of manufacturing a 3D object or pattern by additive manufacturing.

In any formulation of the invention, the method of printing may comprise layer-by-layer deposition of the formulation and photopolymerization to obtain a 3D object or pattern composed of a polymeric material having a Tg higher than 180° C.

In any formulation of the invention, the formulation may comprise a dual-cure material, a multifunctional hardener, and/or cyanate esters.

In any formulation of the invention, the dual-cure material may be BAEMA.

In any formulation of the invention, the multifunctional hardener may be an alkylated melamine, selected from C1-C10alkylated melamine.

In any formulation of the invention, the formulation may be used in DLP printing of a 3D object.

In any formulation of the invention, A 3D object obtained from the formulation may be characterized by a Tg or 241° C., Young's modulus of 2.43 Gpa and an ultimate tensile strength (UTS) value of 37.5 MPa.

In any formulation of the invention, the formulation may comprise a dual-cure material, a multifunctional hardener and/or cyanate esters, and a silica precursor.

In any formulation of the invention, the silica precursor is acryloxymethyl trimethoxysilane (AMTMS).

In any formulation of the invention, the dual-cure material is BAEMA.

In any formulation of the invention, the multifunctional hardener is an alkylated melamine, selected from C1-C10alkylated melamine.

In any formulation of the invention, a 3D object formed of a formulation may characterized by a Tg of 283° C., Young's modulus of 2.85 GPa, and UTS value be of 44.25 MPa.

A printing formulation for DLP, the formulation comprising BAEMA, an alkylated melamine, and/or cyanate esters.

In any formulation of the invention, the alkylated melamine is C1-C10alkylated melamine.

A printing formulation for DLP, the formulation comprising BAEMA, an alkylated melamine and/or cyanate esters and acryloxymethyl trimethoxysilane (AMTMS).

A process for forming a 3D object or pattern, the process comprising inducing polymerization of at least one dual-cure material in presence of a multifunctional curing agent and a photoinitiator, to form a crosslinked polymer structure or pattern, wherein the induction of polymerization comprises irradiation of the at least one dual-cure material in presence of the multifunctional curing agent and the photoinitiator by visible or UV or NIR or IR radiation.

In any process or method of the invention, the process may comprise inducing polymerization by visible or UV or NIR or IR light to form in situ crosslinked polymer structures, followed by thermal curing.

An object formed of any formulation of the invention, the object may be a polymeric object, a structure or a pattern having a Tg higher than 180° C.

In any object of the invention, it may be implemented for use in aerospace aviation, automobile industry, electronic packaging, microelectronic insulation, corrosion resistance, films, medical device, and medical implants.

In any object of the invention, the object may be a polymeric object, a structure or a pattern having a Tg higher than 180° C.

In any object of the invention, the object may be implemented for use in aerospace aviation, automobile industry, electronic packaging, microelectronic insulation, corrosion resistance, films, medical device, and medical implants.

In any object of the invention, may be characterized by a Tg of 241° C., Young's modulus of 2.43 Gpa and an ultimate tensile strength (UTS) value of 37.5 MPa.

In any object of the invention, may be characterized by a Tg value of 283° C., Young's modulus of 2.85 GPa, and UTS value of 44.25 MPa.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows examples of dual epoxy-acrylate resins.

FIG. 2 demonstrates synthesis of the BAEMA dual resin.

FIG. 3 demonstrates the reaction of alkylated melamine with hydroxyl groups of BAEMA resin.

FIG. 4 demonstrates reaction of alkylated melamine with epoxide groups of BAEMA resin.

FIG. 5 presents a SEM micrograph of printed sample containing Cymel NF 2000A and AMTMS as hardeners. The sample was thermal cured @ 275° C.

FIG. 6 presents an XPS of BAEMA cured by Cymel NF 2000A and AMTMS after thermal curing @ 275° C.

FIG. 7 shows a photo of printed woodpiles made of ink cured by Cymel NF 2000A without sol-gel precursor after heat curing @ 180° C. The composition is described in table 6.

FIG. 8 shows printed diamond-lattice shape object and screws made of ink containing Cymel NF 2000A and the sol-gel precursor, (composition is described in table 6) after heat curing @ 180° C.

FIG. 9 presents a reaction of cyanate ester with epoxide groups of BAEMA resin.

FIG. 10 presents images of printed woodpiles and a prism object after heat curing.

FIG. 11 depicts a suggested reaction of phenolic resin with BAEMA.

FIG. 12 shows printed wheels after heat curing at 275° C. The models are based on formulation 2 in table 10, including hydroquinone (0.0007% based on BAEMA) and Sulfurhodamine B sodium salt (0.0005% base on BAEMA).

### DETAILED DESCRIPTION OF THE DRAWING

### Methods

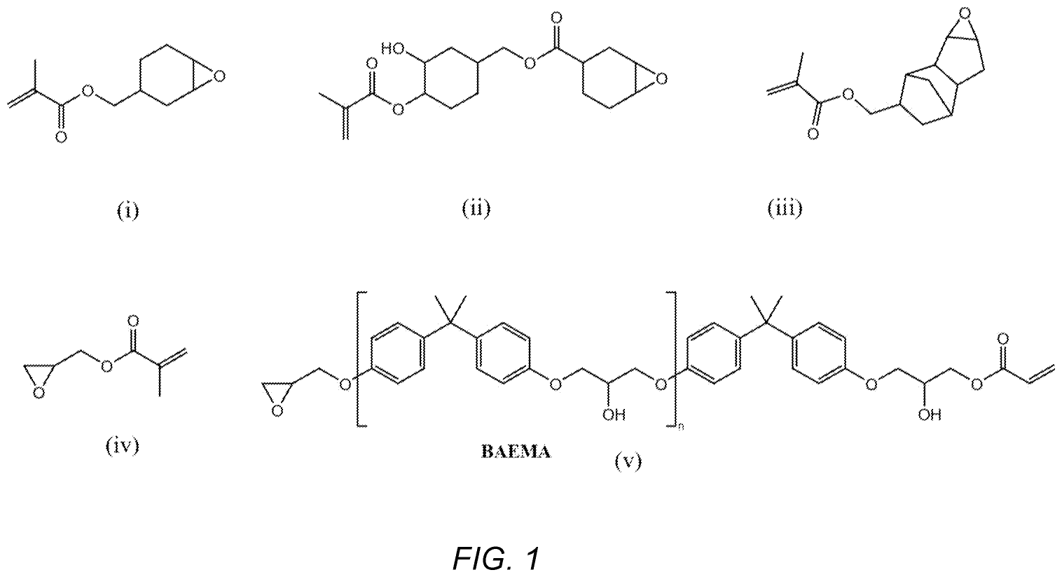

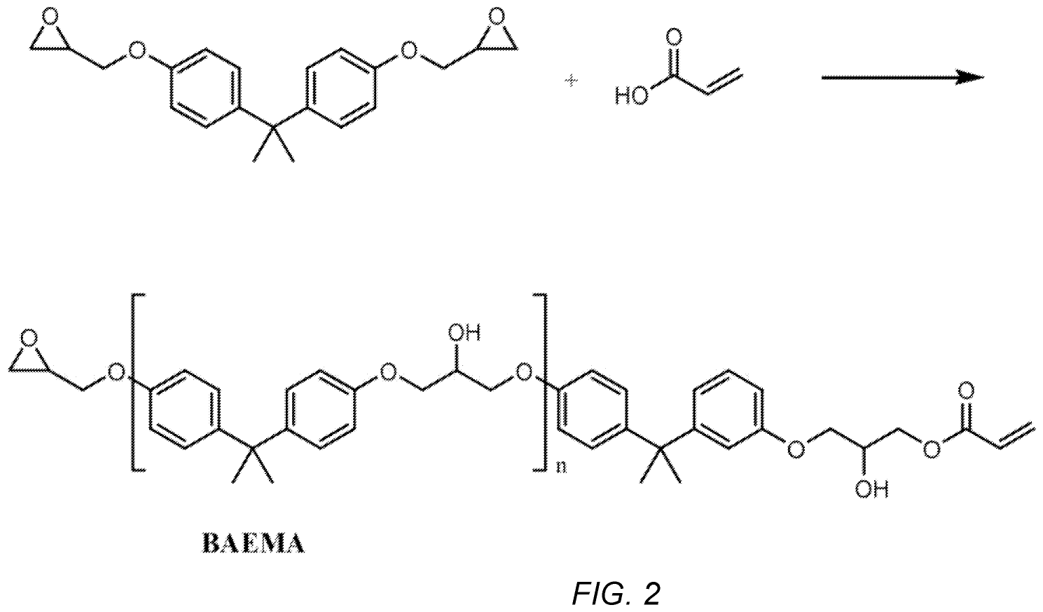

BAEMA (FIG. 1) was synthesized through semi-esterification of the epoxy resins DGEBA with acrylic acid. The synthesized epoxy monoacrylates was characterized via Fourier transforms infrared spectroscopy (FTIR). New absorptions at 1727, and 1406 cm⁻¹ were formed due to the C═O and C═C ethoxyacrylate stretch of the dual cure oligomer. The absorption peak of the epoxide group at 914 cm⁻¹ decreased in intensity compared with the starting material DGEBA. Proton nuclear magnetic resonance spectroscopy (¹H-NMR) showed characterized chemical shifts of BAEMA at δ=6.44, 6.19 and 5.89 ppm corresponding the acrylate group (CH₂═CH), and peaks at 4.4-3.8 ppm relate to CH₂O and CH₂CHOH groups. The calculated conversion of the epoxy group to acrylate was 53%, and the polymerization degree n=2.2.

The oligomer contains traces of unreacted acrylic acid, which can be further utilized as catalyst for the post printing epoxy curing.

### Procedure for Homopolymer Preparation:

The procedure is based on mixing of BAEMA with the relevant solvent at 50° C., to form a clear solution. Next. TPO, optionally DPI and ITX, added and dissolved in the mixture. Additional mixing by Thinky mixer (2 min) followed by defoaming (2 min) formed a transparent homogenous formulation.

### Typical Procedure for Formulation Preparation:

A typical procedure is based on mixing of BAEMA with the relevant solvent, hardener and optionally a sol gel precursor at 50° C., to form a clear blend. Next, the initiators and catalyst are added and dissolved in the mixture. Finally, water was added to the formulation. Additional mixing by Thinky mixer (2 min) followed by defoaming (2 min) formed a transparent homogenous formulation.

### Typical Procedure for Formulations Based on 2 Steps Sol Gel Process:

Sol gel precursor, buffer solution pH=4 and ethanol were heated and stirred at 50° C. for 3 hours. This solution was mixed with a formulation comprising of BAEMA, hardener and relevant initiators/catalyst, (typical procedure demonstrated above). Additional mixing by Thinky mixer (2 min) followed by defoaming (2 min) formed a transparent homogenous formulation.

Samples were casted in molds for mechanical properties characterization, assessed by three-point bending dynamic mechanical analysis (DMA).

Models were printed using an Asiga Max DLP printer with LED wavelength of 385 nm @ 30 mw/cm² and layer thickness of 50-200 μm. Yet, the same printing process can be performed by other stereolithiography-based printers, including and not limited to, SLA, 2-photons and holographic printers, by proper tailoring the components such as photoinitiators and the printing parameters.

Dogbones were printed for ultimate tensile strength measurements.

The length and width of the dog bones are shown, the thickness is 800 μm.

The measurements were performed in an Instron testing machine model 4500.

### EXAMPLES

### Comparative Example 1: Homopolymerization of BAEMA in the Presence of Inert and Reactive Diluents

For homopolymerization of the viscous oligomer BAEMA, a diluent was added. In this comparative example, two diluents were used:
1. A volatile diluent-Methyl ethyl ketone (MEK)
2. A reactive diluent-1-Phenoxy-2-propanol

The components of the inks as shown in Table 1 were mixed at 55° C. to form a clear solution, then, the inks were molded to form DMA samples. The first ink was left overnight at room temperature for MEK evaporation before photocuring, while the second ink based on 1-phenoxy-2-propanol was photocured immediately.
Photocuring conditions: 0.5 min/395 nm.
Thermal Curing: 1 h/100° C. followed by 4 h/275° C., heat rate 10° C./min Similar Tg was formed for the two formulations.

TABLE 1

| | | | | Tg |
|---|---|---|---|---|
| Ink | Component | Name | % Wt. | (° C.) |
| With | Epoxy acrylate | BAEMA | 65.0 | 112 |
| volatile | Diluent | MEK | 32.0 | |
| diluent | Photoinitiators | TPO | 1.3 | |
| | | Ph₂I⁻ PF₆⁺ | 1.3 | |
| | Catalyst | ITX | 0.4 | |
| With | Epoxy acrylate | BAEMA | 87.2 | 117 |
| reactive | Diluent | 1-phenoxy-2- | 8.75 | |
| diluent | | propanol | | |
| | Photoinitiators | TPO | 1.8 | |
| | | Ph₂I⁻ PF₆⁺ | 1.8 | |
| | Catalyst | ITX | 0.45 | |

### Comparative Example 2: Homopolymerization of BAEMA with and without Cationic Photoinitiators

It was discovered that the presence of traces of acrylic acid in the synthesized oligomer, may enable not using a cationic photoinitiator in the formulation. In this comparative example, BAEMA was homopolymerized in two ways:
1. By adding a cationic photoinitiator to the formulation
2. Without cationic photoinitiator

Components of the inks as shown in Table 2 were mixed at 55° C. to form a clear solution, then, molded to form DMA samples.
Photocuring conditions: 0.5 min/295 nm.
Thermal Curing: 1 h/100° C. followed by 4 h/275° C., heat rate 10° C./min

TABLE 2

| | | | | Tg |
|---|---|---|---|---|
| Ink | Component | Name | % Wt. | (° C.) |
| With cationic | Epoxy acrylate | BAEMA | 65.0 | 112 |
| Photoinitiator | Diluent | MEK | 32.0 | |
| | Photoinitiators | TPO | 1.3 | |
| | | Ph₂I⁻ PF₆⁺ | 1.3 | |
| | Catalyst | ITX | 0.4 | |
| Without | Epoxy acrylate | BAEMA | 65.0 | 134 |
| cationic | Diluent | MEK | 33.7 | |
| Photoinitiator | Photoinitiator | TPO | 1.3 | |

The resulting Tg shows that due to the presence of acid in the oligomer, a heat curing of the epoxide occurs without a cationic photocatalyst. This result has a significant impact on the overall cost reduction of the printing formulation.

Dogbones were printed from both inks (table 2) and tested by the Instron testing machine. The results of the mechanical properties are attached in Table 3.

TABLE 3

| | | | | | | Tensile |
|---|---|---|---|---|---|---|
| | | | | Ultimate | | Tough- |
| | Young's | Yield | Yield | tensile | Max | ness |
| | modulus | Strength | Strain | strength | Strain | (MJ/ |
| | (MPa) | (MPa) | (%) | (MPa) | (%) | m\hat{ }3) |
| With cationic | 2062 | 26.01 | 1.2 | 41.85 | 2.5 | 2430 |
| Photoinitiator | | | | | | |
| Without | 1772 | 11.42 | 0.6 | 20.14 | 2.2 | 1436 |
| cationic | | | | | | |
| Photoinitiator | | | | | | |

It can be concluded from table 3 that additional cationic photoinitiator may be required to obtain a homopolymer with higher mechanical properties.

### Example 3: Formulation with a Hardener Alkylated Melamine

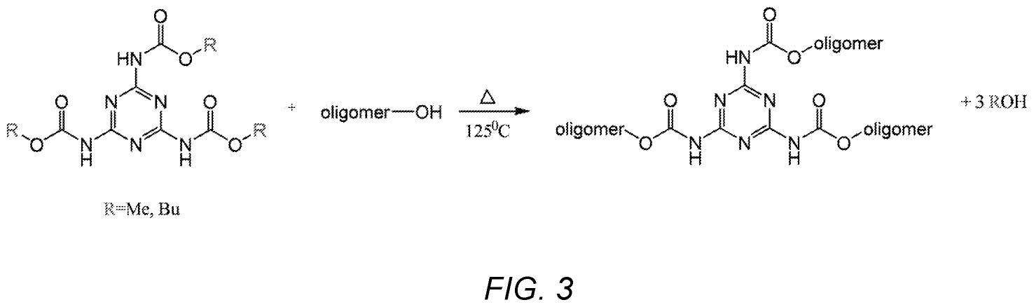

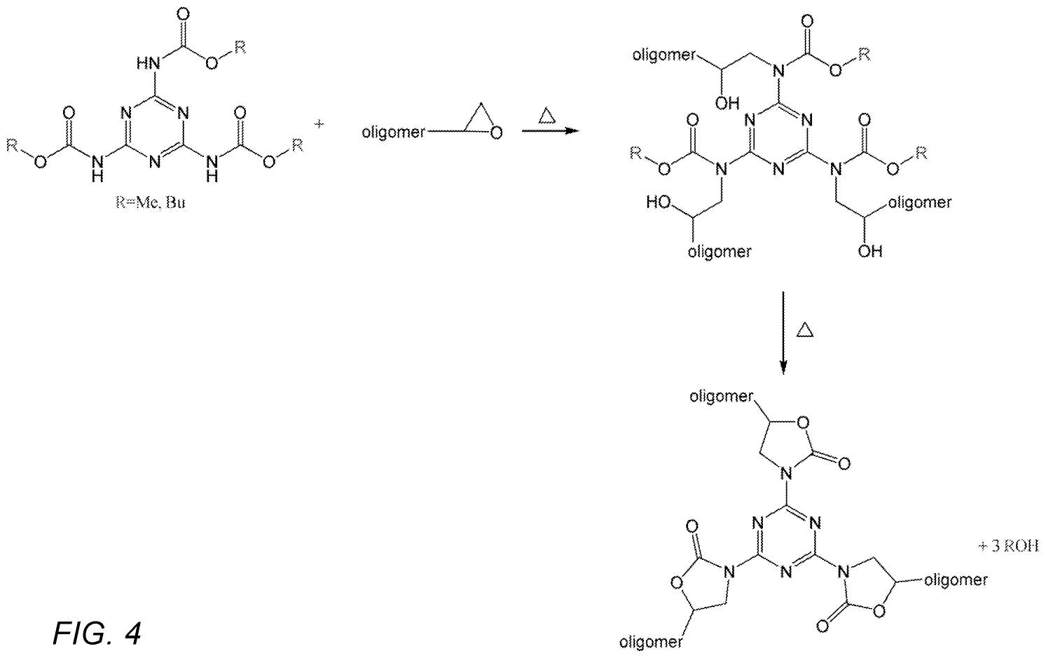

When alkylated melamine is heated with the oligomer, it reacts with the OH groups of BAEMA to form urethane linkages (FIG. 3). Reaction with the epoxide functional groups forms N-substituted carbamate and oxazolidone crosslinks (FIG. 4). This process increases the rigidity of the final polymer.

This example shows the effect of adding a hardener on the mechanical and thermal properties of the resulting polymer, while evaluating the hardener:oligomer ratio. All inks presented here as examples are based on: BAEMA:Cymel NF 2000A as a hardener, and the photoinitiator TPO (2% wt of BAEMA) (see Table 4). The samples were photocured 0.5 min/395 nm, then heated 1 h/100° C. followed by 4 h/275° C. with a heat rate of 10° C./min.

TABLE 4

| | BAEMA:alkylated | Curing | Tg |
|---|---|---|---|
| Ink | melamine (% wt) | conditions | (° C.) |
| 1 | 1:0 | 1 h/100° C. + | 134 |
| | | 4 h/275° C. | |
| 2 | 1:1 | 1 h/100° C. + | 241 |
| | | 4 h/275° C. | |
| 3 | 2:1 | 1 h/100° C. + | 187 |
| | | 4 h/275° C. | |
| 4 | 3.2:1 | 1 h/100° C. + | 147, 190 |
| | | 4 h/275° C. | |

As clearly indicated in table 4, the addition of a melamine-based hardener increases the Tg dramatically from 134° C. for the homopolymer up to 241° C.

### Example 4: Effect of Curing Temperature

In this example, the effect of heat curing temperature on the mechanical properties of the final polymer was evaluated. All samples are based on ink 2 shown in Table 4, containing BAEMA:Cymel NF 2000A:TPO 49:49:2 (wt %). The samples were photocured 0.5 min/395 nm. Tg and mechanical tests results are shown in Table 5.

TABLE 5

| | | | | | Ultimate | | |
|---|---|---|---|---|---|---|---|
| | | Young's | Yield | Yield | tensile | Max | Tensile |
| Curing | Tg | modulus | Strength | Strain | strength | Strain | Toughness |
| conditions | (° C.) | (MPa) | (MPa) | (%) | (MPa) | (%) | (MJ/m\hat{ }3) |
| 1 h/100° C., | 152 | Not Detected | | | | | |
| 2 h/180° C. | | | | | | | |
| 1 h/100° C., | 187 | 2239 | 11.55 | 0.5 | 35.23 | 1.7 | 1675 |
| 4 h/240° C. | | | | | | | |
| 1 h/100° C., | 241 | 2439 | 15.96 | 0.6 | 37.46 | 2.8 | 3713 |
| 4 h/275° C. | | | | | | | |

It can be concluded from Table 5 that increasing the temperature improves epoxide curing. As a result, the Tg and the mechanical properties of the final polymer improved dramatically. The modulus of a cured polymer @ 275° C. reached the value of 2439 MPa and the toughness was doubled compared to curing @ 180° C. It should be noted that heat curing at this high temperature leads to objects having a dark brown color.

### Example 5: Addition of a Sol Gel Precursor with Melamine

This example presents inks based on alkylated melamine as a hardener, with and without the addition of a sol-gel precursor (Table 6).
The ratio BAEMA:hardener˜1:1.
Photocuring conditions: 0.5 min/395 nm.
Thermal Curing: 1 h/100° C. followed by 4 h/275° C., heat rate 10° C./min.

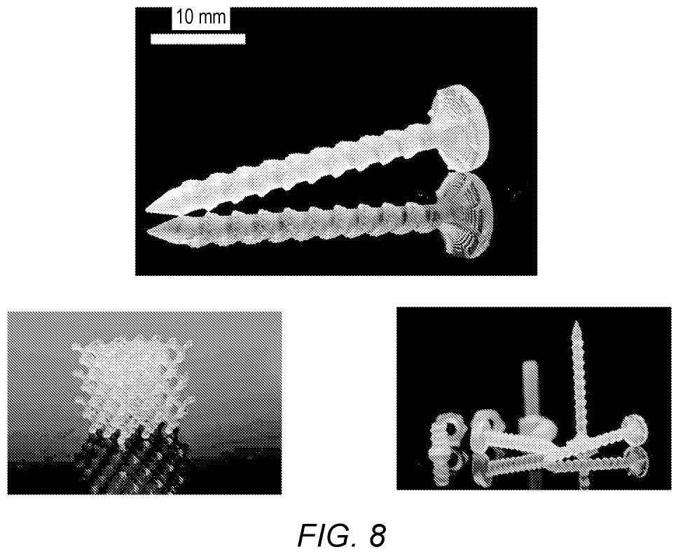

Printed models are shown in FIG. 7 and FIG. 8, indicating that both inks are printable.

TABLE 6

| | | | | Tg |
|---|---|---|---|---|
| Ink | Component | Name | % Wt. | (° C.) |
| Without Sol- | Epoxy acrylate | BAEMA | 49.0 | 241 |
| Gel precursor | Hardener | Cymel NF | 49.0 | |
| | | 2000A | | |
| | Photoinitiator | TPO | 2.0 | |
| With | Epoxy acrylate | BAEMA | 48 | 280 |
| Sol-Gel | Hardener | Cymel NF | 47.5 | |
| precursor | | 2000A | | |
| | Photoinitiator | TPO | 1.0 | |
| | Sol-Gel | Acryloxymethyl | 2.5 | |
| | precursor | trimethoxysilane | | |
| | | (AMTMS) | | |
| | Sol-Gel | Water | 1.0 | |
| | precursor | | | |
| | additive | | | |

The results in Table 6 show the high Tg of polymer cured by alkylated melamine. Clearly, the addition of a soluble sol-gel precursor at a very low concentration to the formulation increased significantly the Tg from 241 up to 280° C.

TABLE 7

| | | | | Ultimate | | |
|---|---|---|---|---|---|---|
| | Young's | Yield | Yield | tensile | Max | Tensile |
| | modulus | Strength | Strain | strength | Strain | Toughness |
| | (MPa) | (MPa) | (%) | (MPa) | (%) | (MJ/m\hat{ }3) |
| Without | 2439 | 15.96 | 0.6 | 37.46 | 2.8 | 3713 |
| Sol-Gel | | | | | | |
| precursor | | | | | | |
| With | 2492 | 27.63 | 1.0 | 44.25 | 2.3 | 2878 |
| Sol-Gel | | | | | | |
| precursor | | | | | | |

The measured tensile properties in Table 7 indicate that the strength and modulus increase when the sol-gel precursor is added. However, the toughness of the polymer decreases from 3713 to 2878 MJ/m\hat{ }3. This is possibly resulted by lowering of the crosslinking density of the epoxide-melamine system.

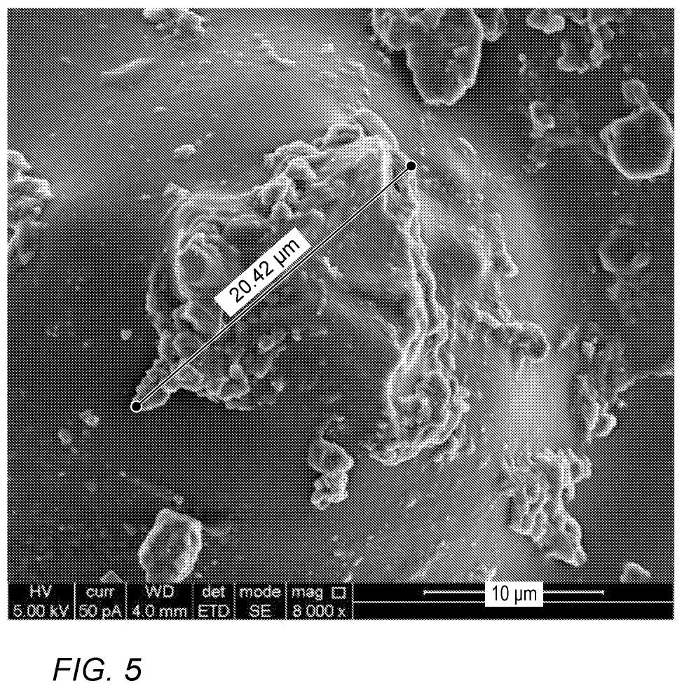

SEM was used to observe the microstructure of the printed samples after thermal curing. The sample containing alkylated melamine as a hardener has a homogeneous smooth surface. However, sample cured by alkylated melamine and AMTMS has amorphous silicates, with a size range of few to tens microns, that were detected by SEM ESD analysis (FIG. 5).

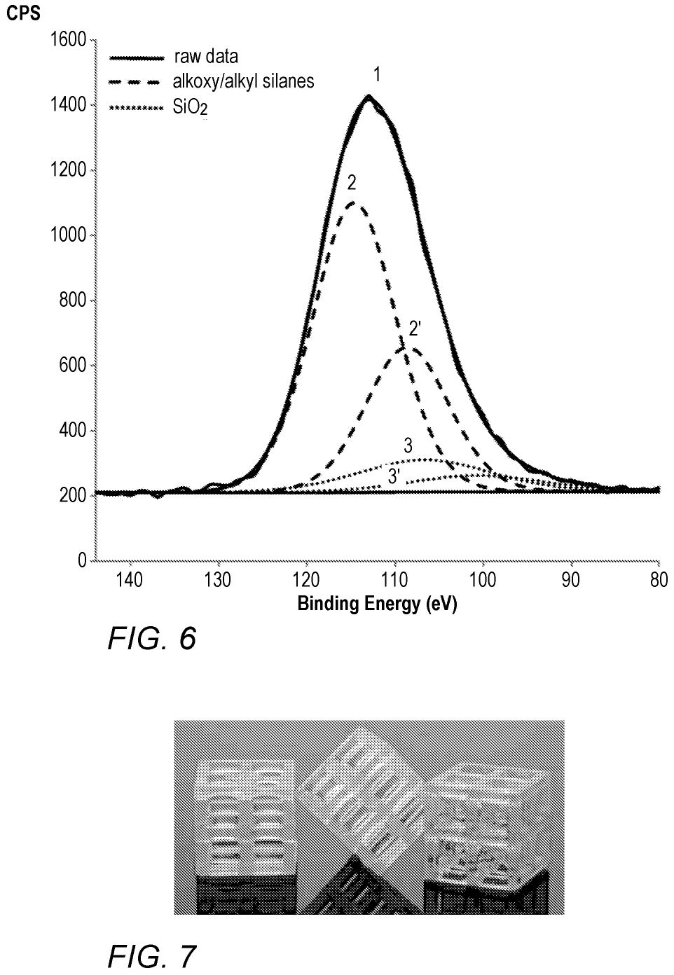

The presence of silicon oxide and silane in the polymer was also detected by X-Ray Photoelectron Spectroscopy (XPS). The survey scan shows that the polymer contains carbon (78.35%), nitrogen (5.38%), oxygen (13.21%) and silicone (3.06% atomic concentration) (FIG. 6). A peak at 102.5 eV (2, spin 3/2) corresponds to the binding energy of silanes and silicates, indicating that the AMTMS that was chemically bonded to the epoxy network, did not fully hydrolyze and polymerize to silicon oxide. The second peak at 103.294 eV (3, spin 3/2) refers to SiO₂. Each one of these two peaks has another peak shifted with −0.6 eV (2′, 3′). According to the ratio between the two doublets, it was found that 15% of the Silicon precursor was fully converted to SiO₂.

FIG. 7 shows printed woodpiles made of ink cured by Cymel NF 2000A without sol-gel precursor after heat curing @ 180° C. The composition is described in table 6.

For printing purposes, the formulation presented in table 6 included hydroquinone (0.004% based on BAEMA) and Sulfurhodamine B sodium salt (0.0005% base on BAEMA), for achieving a good resolution.

FIG. 8 below shows printed diamond-lattice shape object and screws made of ink containing Cymel NF 2000A and the sol-gel precursor, (composition is described in table 6) after heat curing @ 180° C. For printing purposes, the formulation presented in table 6 includes hydroquinone (0.004% based on BAEMA) and Sulfurhodamine B sodium salt (0.0005% base on BAEMA), for addressing optimal printability.

Samples shown in FIG. 7 and FIG. 8 were printed by Asiga Max DLP printer. The build parameters are the following:
slice thickness: 0.2 mm,
heat temp: 50° C. (actual temp 32.6° C.),
light intensity: 29.28 mW/cm⁻¹,
exposure time burn in: 10 sec,
exposure time other layers: 3 sec,
separation velocity: 5 mm/sec,
separation distance: 5 mm,
approach velocity: 0.5 mm/s,
wait time (after exposure): 2 sec,
wait time (after separation): 2 sec,
wait time (after approach): 2 sec.

The printed models were washed in a solution of 10% Cymel NF 2000A/CH₂Cl₂ in order to remove the access ink. The solvent was evaporated at room temperature overnight, then the model was heated to 70° C. under vacuum for 1 h. After cooling, the printed models in FIG. 8 were thermally Cured: 1 h/100° C. followed by 4 h/180° C. (in order to avoid dark brown samples).

Unlike the common approach of blending epoxy and acrylate monomers to enable both photopolymerization and thermal curing, here we present the formation and application of a bifunctional oligomer, having both acrylate and epoxy groups within the same molecule. This oligomer is combined with unique multifunctional hardeners, alkylated melamine (Cymel), and silica precursor (AMTMS). The fabrication process is composed of DLP printing, thus forming the required object by photopolymerization of the oligomer, followed by heat curing the epoxides with Cymel. This specific hardener led to the formation of a highly crosslinked, high-performance polymer characterized by superior properties: excellent Tg (241° C.) with Young's modulus of 2.43 Gpa and UTS value of 37.5 MPa.

Further addition of the sol-gel dual precursor AMTMS provided a unique multifunction: photopolymerization, crosslinking, and forming silica particles. The combination of all three led to the extremely high Tg value of 283° C., excellent Young's modulus of 2.85 GPa, and UTS value of 44.25 MPa.

### Example 6: Cyanate Ester as a Hardener

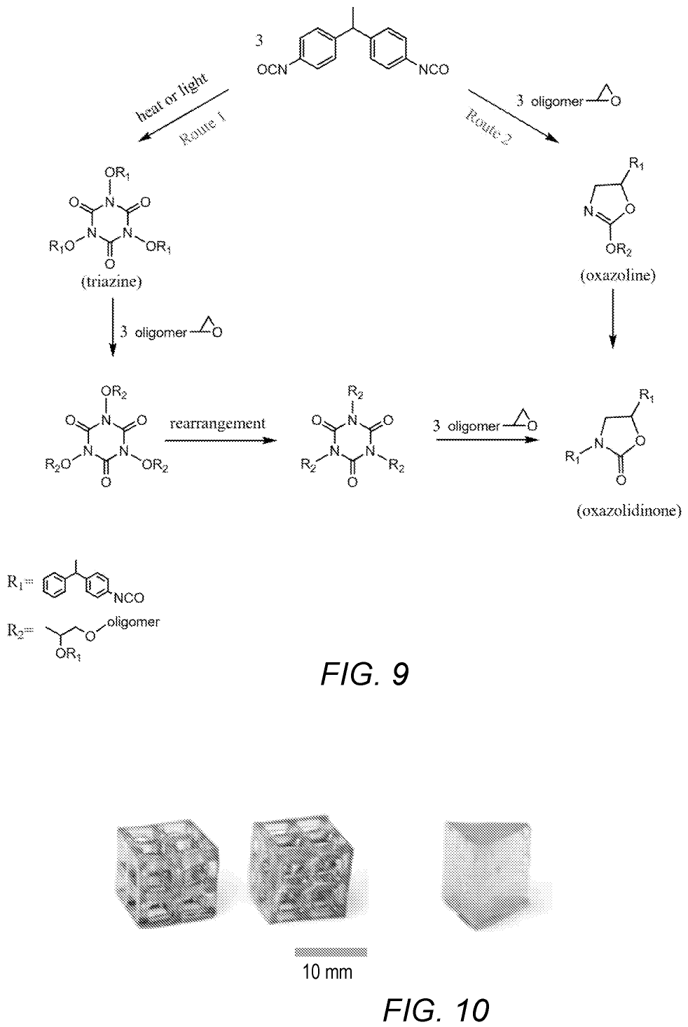

Cyanate ester may react with epoxide groups of BAEMA in two routes, to form a highly crosslinked polymers, based on oxazolidinone and triazine rings (FIG. 9).

In this example, the hardener is with a ratio of ˜1:1 to BAEMA (Table 8). The Tg of the cured polymer is 208° C., which is much higher than that of the homopolymer only (described in table 1).

TABLE 8

| | | | Tg |
|---|---|---|---|
| Component | Name | % Wt. | (° C.) |
| Epoxy acrylate | BAEMA | 48.0 | 208 |
| Hardener | 1,1-Bis(4-cyanatophenyl) | 48.4 | |
| | ethane [47073-92-7]* | | |
| Photoinitiator | TPO | 2.0 | |
| Catalyst | Zinc acetylacetonate | 1.6 | |
| | hydrate in isobornyl | | |
| | acrylate | | |

*AroCy ® L-10 cyanate ester supplied by Huntsman

Photocuring conditions: 0.5 min/395 nm.
Thermal Curing: 1 h/120° C., 2 h/180° C., 1 h/220° C., 1 h/240° C., heat rate 10° C./min.

Dogbones were printed from the ink (table 8) and tested by the Instron testing machine. The results of the mechanical properties are attached in Table 9.

TABLE 9

| Young's | Yield | Yield | Ultimate tensile | Max | Tensile |
|---|---|---|---|---|---|
| modulus | Strength | Strain | strength | Strain | Toughness |
| (MPa) | (MPa) | (%) | (MPa) | (%) | (MJ/m\hat{ }3) |
| 1767 | 30.16 | 1.6 | 85.35 | 5.7 | 1335 |

Based on the results in table 9, it can conclude that this specific cyanate ester hardener forms a polymer with relatively low mechanical properties, compared with the alkylated melamine hardener.

Printed woodpiles and a prism object after heat curing are shown in FIG. 10. For printing purposes, the formulation presented in Table 8 includes hydroquinone (0.0007% based on BAEMA) and Sulfurhodamine B sodium salt (0.0005% based on BAEMA).

The build printing parameters are the following:
slice thickness: 0.2 mm,
heat temp: 50° C. (actual temp 35.0° C.),
light intensity: 29.19 mW/cm⁻¹,
exposure time burn in: 20 sec,
exposure time other layers: 6 sec,
separation velocity: 0.5 mm/sec,
separation distance: 5 mm,
approach velocity: 0.5 mm/s,
wait time (after exposure): 2 sec,
wait time (after separation): 2 sec,
wait time (after approach): 2 sec.

The models were washed in acetone before heat curing.

### Example 7: Phenolic Resin as a Hardener

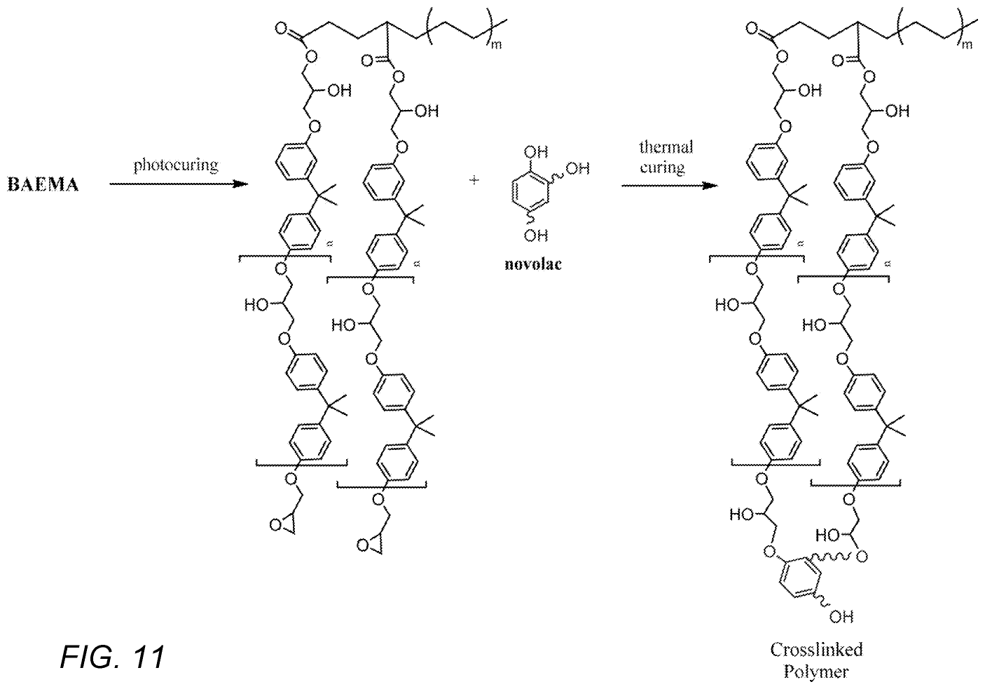

The phenolic resin used reacts with the epoxide groups of BAEMA during the thermal curing. The process requires a catalyst, and the result is a crosslinked polymer (FIG. 11).

A comparative example of inks based on a phenolic resin as a hardener, with and without sol gel precursor is presented in Table 10. The ratio BAEMA:hardener is 1:1. In this example, ink 2 includes additional acrylate monomer for printing improvement.

TABLE 10

| | | | Approx. | Tg |
|---|---|---|---|---|
| Ink | Component | Name | % Wt. | (° C.) |
| 1 | Epoxy acrylate | BAEMA | 49.0 | 125, |
| | Hardener | Phenolic | 49.0 | 230 |
| | | resin* | | |
| | Photoinitiator | TPO | 2.0 | |
| 2 | Epoxy acrylate | BAEMA | 45.0 | 167, |
| | Hardener | Phenolic resin | 45.0 | 255 |
| | | (Phenodur PR | | |
| | | 401/72B) | | |
| | Photoinitiator | TPO | 1.0 | |
| | Sol-Gel | AMTMS | 2.5 | |
| | precursor | | | |
| | Printing | Isobornyl | 6.5 | |
| | additive | acrylate | | |

*phenolic resin = Phenodur PR 401/72B

Photocuring conditions: 0.5 min/295 nm.
Thermal Curing: 1 h/100° C. followed by 4 h/275° C., heat rate 10° C./min.

In both inks, no catalyst for the epoxide-hydroxyl reaction is needed. This is probably due to the presence of residues of acrylic acid in the oligomer, which makes the external addition of acid catalyst unnecessary.

In both inks, the cured polymer has a major Tg peak and a “shoulder” with a higher Tg. This can be explained by the potential existence of two phases formed in the final polymers. Comparison between the two inks indicates a significant increase of the Tg due to the addition of AMTMS sol-gel precursor.

The results of the mechanical properties of printed dog bones are presented in Table 11.

TABLE 11

| | | | | Ultimate | | |
|---|---|---|---|---|---|---|
| | Young's | Yield | Yield | tensile | Max | Tensile |
| | modulus | Strength | Strain | strength | Strain | Toughness |
| | (MPa) | (MPa) | (%) | (MPa) | (%) | (MJ/m\hat{ }3) |
| Without | 1327 | 7.02 | 0.3 | 26.1 | 3.6 | 3576 |
| Sol-Gel | | | | | | |
| Precursor | | | | | | |
| With | 2172 | 21.62 | 1.0 | 50.6 | 2.5 | 3269 |
| Sol-Gel | | | | | | |
| Precursor | | | | | | |

The measured mechanical properties in Table 11 indicates that the strength and modulus improved significantly with addition of the sol gel precursor. In addition, this phenolic resin reacts with BAEMA to forms polymers with a high tensile toughness.

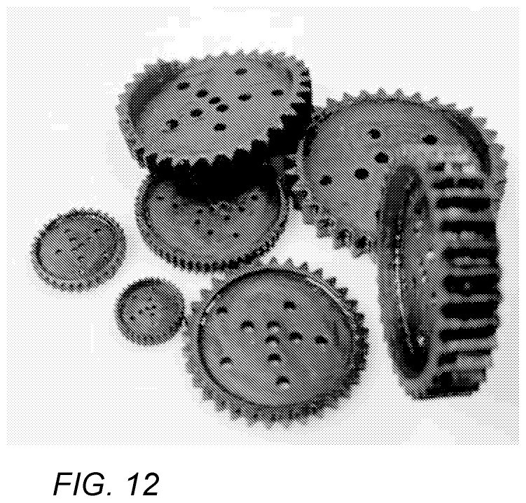

FIG. 12 shows printed wheels after heat curing at 275° C. The models are based on formulation 2 in table 10, including hydroquinone (0.0007% based on BAEMA) and Sulfurhodamine B sodium salt (0.0005% base on BAEMA).

The build printing parameters are the following:
slice thickness: 0.2 mm,
heat temp: 50° C. (actual temp 32.0° C.),
light intensity: 20.0 mW/cm⁻¹,
exposure time burn in: 10 sec,
exposure time other layers: 5 sec,
separation velocity: 0.5 mm/sec,
separation distance: 5 mm,
approach velocity: 0.5 mm/s,
wait time (after exposure): 2 sec,
wait time (after separation): 2 sec,
wait time (after approach): 2 sec.

The models were washed in MEK followed by isopropanol, before heat curing.

1.-62. (canceled)

63. A formulation comprising a dual-cure material being in a form of a monomer or an oligomer, and a multifunctional curing agent, for use in a method of additive manufacturing, wherein the formulation optionally comprises an ink carrier or a carrier suitable for printing.

64. The formulation according to claim 63, wherein the dual-cure material is a polymerizable monomer or oligomer having one or more epoxy functionality and one or more acrylate functionality.

65. The formulation according to claim 63, wherein the dual-cure material is of the structure (I): 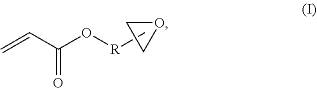
wherein the oxirane ring is associated with group R via any of the oxirane carbon atoms or is fused to a group R.

66. The formulation according to claim 65,
wherein R is a ring structure or a functionality having a cyclic or an aromatic group, wherein the oxirane ring is fused thereto; or
wherein R is a carbon-based group selected from aliphatic groups, aromatic groups, heteroaromatic groups, carbocyclic groups, saturated groups, and unsaturated groups, or
wherein R is repeated 1 or more times, wherein each R is an alkylene group having between 1 and 100 carbon atoms, an alkenylene group having between 2 and 100 carbon atoms or an alkynylene group having between 2 and 100 carbon atoms, each of which being optionally substituted, or
wherein R is a carbocyclyl group or an aromatic or a heteroaromatic group, that is optionally substituted, or wherein R is an alkylene group comprising 1 to 5 carbon atoms.

67. The formulation according to claim 1, wherein the dual-cure material is of general structure (II): 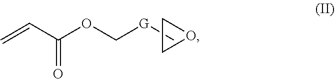
wherein G is a carbon group comprising between 2 and 50 carbon atoms, and optionally comprising one or more ring structures selected from 4-, 5- and 6-membered carbocyclic, aromatic or heteroaromatic ring systems.

68. The formulation according to claim 67, wherein G is selected from: 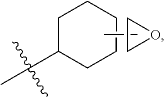
wherein the dashed line designates a bond of connectivity to the methylene carbon in structure (II) and wherein the oxirane ring may be substituted on any of the ring positions of the 6-membered ring or is fused to any bond of the 6-membered ring; 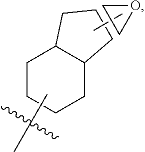
wherein the dashed line designates a bond of connectivity to the methylene carbon in a structure (II), said connectivity being through any of the carbon atoms of the 6-membered ring, and wherein the oxirane ring is substituted on any of the ring positions of the 5-membered ring or is fused to any bond of the 5-membered ring; 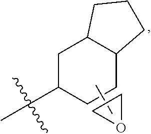
wherein the dashed line designates a bond of connectivity to the methylene carbon in a structure (II), and wherein the oxirane ring is substituted on any of the ring positions of the 6-membered ring or is fused to any bond of the 6-membered ring; 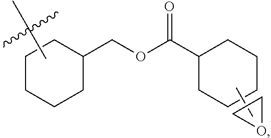
wherein the dashed line designates a bond of connectivity to the methylene carbon in a structure (II), and wherein the oxirane ring is substituted on any of the ring positions of the 6-membered ring or is fused to any bond of the 6-membered ring.

69. The formulation according to claim 63, wherein the dual-cure material is selected from:

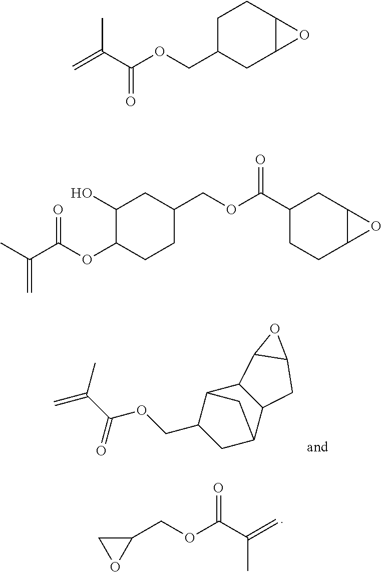

70. The formulation according to claim 63, wherein the dual-cure material is BAEMA.

71. The formulation according to claim 63, wherein the multifunctional curing agent is selected from methylene dianiline, diethyl aminopropylamine, diethylenetriamine, ethylenediamine, m-phenylenediamine, tris-(dimethylaminomethyl) phenol, triethylenetetramine, dicyandiamide, isopropyl metaphenylenediamine, hexahydrophthalic anhydride, 4,4-methylen-bis-(2-chloraniline), alkylated melamines, cyanate esters, polyphenols and aromatic diisocyanate.

72. The formulation according claim 63, wherein the multifunctional curing agent is selected from melamine and alkylated melamine.

73. The formulation according to claim 63, further comprising an inorganic precursor or a sol gel precursor soluble in the formulation.

74. The formulation according to claim 63, further comprising a photoinitiator suitable for generating an active species capable of inducing polymerization.

75. The formulation according to claim 63, the formulation comprising a dual-cure material, a multifunctional hardener, and/or cyanate esters.

76. The formulation according to claim 75, wherein the dual-cure material is BAEMA and wherein the multifunctional hardener is an alkylated melamine, selected from C1-C10 alkylated melamine.

77. A process for forming a 3D object or pattern, the process comprising inducing polymerization of at least one dual-cure material in presence of a multifunctional curing agent and a photoinitiator, to form a crosslinked polymer structure or pattern, wherein the induction of polymerization comprises irradiation of the at least one dual-cure material in presence of the multifunctional curing agent and the photoinitiator by visible or UV or NIR or IR radiation.

78. The process according to claim 77, wherein the process comprises inducing polymerization by visible or UV or NIR or IR light to form in situ crosslinked polymer structures, followed by thermal curing.

79. An object formed of a formulation according to claim 63, the object being a polymeric object, a structure or a pattern having a Tg higher than 180° C.

80. The object according to claim 79, implemented for use in aerospace aviation, automobile industry, electronic packaging, microelectronic insulation, corrosion resistance, films, medical device, and medical implants.

81. An object formed of a process according to claim 79, the object being a polymeric object, a structure or a pattern having a Tg higher than 180° C.

82. The object according to claim 79, characterized by a Tg of 241° C., Young's modulus of 2.43 Gpa and an ultimate tensile strength (UTS) value of 37.5 MPa; or characterized by a Tg value of 283° C., Young's modulus of 2.85 GPa, and UTS value of 44.25 MPa.
